(19) United States
(12) Patent Application Publication
(10) Pub. No.: US 2018/0207725 A1
(43) Pub. Date: Jul. 26, 2018

(54) SYSTEM AND METHOD FOR FABRICATING 3D METAL STRUCTURE

(71) Applicant: The Chinese University of Hong Kong, Hong Kong (CN)

(72) Inventors: Shih-Chi Chen, Shatin (CN); Dien Wang, Shatin (CN); Chenyang Wen, Shatin (CN); Yina Chang, Shatin (CN); Dapeng Zhang, Shatin (CN)

(21) Appl. No.: 15/412,201

(22) Filed: Jan. 23, 2017

(51) Int. Cl. B22F 3/24; B22F 3/105; B33Y 10/00; B33Y 30/00; B33Y 40/00; B23K 26/342; B23K 26/066

(52) U.S. Cl. CPC B22F 3/24; B22F 3/1055; B33Y 10/00; B33Y 30/00; B22F 2003/247; B23K 26/342; B23K 26/066; B22F 2003/1056; B22F 2003/1058; B33Y 40/00

(57) ABSTRACT

The present invention discloses methods and systems for fabricating a 3D metal structure. The method may comprises: forming one or more layers successively on a substrate, each of the layers comprising a structural material or a sacrificial material; laser machining, by a pulsed laser, each of the formed layers based on a photomask corresponding to the structure to be fabricated; and removing redundant materials from the formed layers to release the fabricated three-dimensional metal structure. The system and method for fabricating a 3D metal structure provided in the present application can fabricate a metal structure at nanometer level resolution with high throughout.

### TECHNICAL FIELD

The present invention relates to the field of three-dimensional (3D) printing, and more specifically, to a system and a method for fabricating a 3D metal structure.

### BACKGROUND OF THE APPLICATION

3D printing, also known as additive manufacturing (AM), refers to processes used to synthesize a three-dimensional object in which successive layers of material are formed under computer control to create an object.

In the existing additive manufacturing system, the powder bed system is widely used and commercially available, in which high power continuous wave (cw) laser or electron beam is used as an energy source. The powder bed system may print high resolution features (50-100 μm) and no support structure is required during the process. However, the build volume is restricted to the processing chamber size and scan range. Another additive manufacturing technique, the electrodeposition fabrication (EFAB) process is suitable for fabricating metal structures at micrometer scale. However, an instant mask is needed for each layer and large/complex structures may require a large number of masks, making the process prohibitively expensive

Currently, it is impossible for the commercial systems to print micro-scale or nano-scale objects.

### SUMMARY OF THE APPLICATION

An objective of the present application is to provide a method and a system for fabricating a 3D metal structure, in order to address at least one of the above mentioned problems.

The system and method for fabricating the 3D metal structure provided in the present application can fabricate the metal structure at nanometer level resolution with high throughout. Comparing with existing 3D printing technologies, the present method and the system provides the following distinct advantages: (1) nanometer level lateral and axial printing resolutions, (2) high throughput (˜1000 times faster), (3) pure and dense metal structures, and (4) the capability of fabricating arbitrary structures.

In a first aspect, the present application discloses a method for fabricating a three-dimensional metal structure. The method may comprise: forming one or more layers successively on a substrate, wherein each of the layers may comprise a sacrificial material or a structural material; laser machining, by a pulsed laser, each of the formed layers based on a photomask corresponding to the structure to be fabricated; and removing redundant materials from the formed layers to release the fabricated three-dimensional metal structure.

In another aspect, the present application discloses a system for fabricating a three-dimensional metal structure. The system may comprise: at least one processor; and a memory storing instructions, which when executed by the at least one processor, cause the at least one processor to perform operations comprising: forming one or more layers successively on a substrate, wherein each of the layers may comprise a sacrificial material or a structural material; laser machining, by a pulsed laser, each of the formed layers based on a photomask corresponding to the structure to be fabricated; and removing redundant materials from the formed layers to release the fabricated three-dimensional metal structure.

In still another aspect, the present application discloses a system for fabricating a three-dimensional metal structure. The system may comprise: a pulsed laser source for providing pulsed light sheets; a digital micromirror device for generating a programmable photomask; a deposition device for depositing a sacrificial material or a structural material; at least one processor; and a memory storing instructions, which when executed by the at least one processor, cause the at least one processor to perform operations, the operations comprising: depositing one of the sacrificial material and the structural material on a substrate to form a first layer; patterning the formed layer by the pulsed light sheets laser in a parallel approach, based on the photomask corresponding to the structure to be fabricated; depositing the other one of the sacrificial material and the structural material on the patterned layer to form a further layer; planarizing the deposited layer by the pulsed light sheets; repeating above steps until a final layer is formed; and removing redundant materials by an etchant from the formed layers to release the fabricated three-dimensional metal structure.

In another aspect, the present application discloses a storage medium readable by a computer encoding a computer program for execution by the computer to carry out a method for fabricating a three-dimensional metal structure, the computer program comprising: forming one or more layers successively on a substrate, wherein each of the layers may comprise a sacrificial material or a structural material; laser machining, by a pulsed laser, each of the formed layers based on a photomask corresponding to the structure to be fabricated; and removing redundant materials from the formed layers to release the fabricated three-dimensional metal structure.

### BRIEF DESCRIPTION OF THE DRAWING

Other features, objects and advantages of the present application will become more apparent from a reading of the detailed description of the non-limiting embodiments, said description being given in relation to the accompanying drawings, among which:

FIG. 1 illustrates an exemplary flowchart of the method for fabricating a 3D metal structure according to an embodiment of the present application;

FIG. 2 illustrates exemplary flows of the method for fabricating a 3D metal structure according to an embodiment of the present application;

FIG. 3 illustrates a schematic block diagram of a system for fabricating a 3D metal structure according to an embodiment of the present application;

FIG. 4 illustrates an exemplary configuration of a system for fabricating a 3D metal structure according to an embodiment of the present application;

FIG. 5 illustrates SEM images of two exemplary results formed by the patterning process of the present method according to an embodiment of the present application;

FIG. 6 illustrates an exemplary 10-layer log-pile structure fabricated by the present method according to an embodiment of the present application, wherein 6(A) is an isometric view and 6(B) is a zoom-in view;

FIG. 7 illustrates an exemplary 2-layer suspended nanowire array structure fabricated by the present method according to an embodiment of the present application, wherein 7(A) is a top view and 7(B) is a zoom-in view;

FIG. 8 illustrates exemplary mechanical microstructures fabricated by the present method according to an embodiment of the present application, wherein 8(A) illustrates a 2-layer spur gear and 8(B) illustrates a 6-layer chain structure; and

FIG. 9 illustrates a schematic structural diagram of a computer system that is adapted for implementing the method and the apparatus according to an embodiment of the present application.

### DETAILED DESCRIPTION

The present application will be further described in detail in conjunction with the accompanying drawings and embodiments. It should be understood that the specific embodiments described herein are provided to illustrate the present invention, instead of limiting the present invention. It also should be noted that only parts related to the present invention are shown in the figures for convenience of description.

It should be noted that, the embodiments of the present application and the features in the present application, on a non-conflict basis, may be combined with each other. The present application will be further described in details below in conjunction with the accompanying drawings and embodiments.

Disclosed herein are a system and a method for fabricating a 3D metal structure. According to the present application, pure and dense metal structures can be fabricated with nanometer level resolution and high throughput (˜1000 times faster).

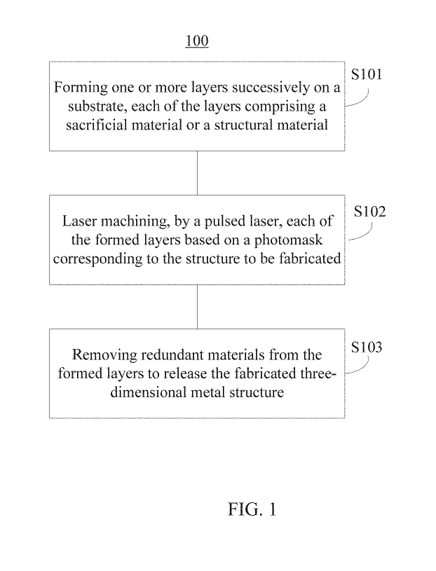

FIG. 1 illustrates an exemplary flowchart of the method 100 for fabricating a 3D metal structure according to an embodiment of the present application. For simplicity of explanation, the methods (or algorithms) are depicted and described as a series of acts. It is to be understood and appreciated that the various embodiments are not limited by the acts illustrated and/or by the order of acts. For example, acts can occur in various orders and/or concurrently, and with other acts not presented or described herein. Furthermore, not all illustrated acts may be required to implement the methods. In addition, the methods could alternatively be represented as a series of interrelated states via a state diagram or events. Additionally, the methods described hereinafter are capable of being stored on an article of manufacture (e.g., a machine-readable storage medium) to facilitate transporting and transferring such methodologies to computers. The term article of manufacture, as used herein, is intended to encompass a computer program accessible from any computer-readable device, carrier, or media, including a non-transitory machine-readable storage medium.

As show in FIG. 1, at step S101, one or more layers are formed successively on a substrate, wherein each of the layers may comprise a sacrificial material or a structural material. At step S102, each of the formed layers is laser machined by a pulsed laser, based on an arbitrary photomask corresponding to the structure to be fabricated. Then, at step S103, redundant materials are removed from the patterned layer to release the fabricated three-dimensional metal structure.

Comparing the continuous wave or nanosecond lasers, the pulsed laser is used in the present application to substantially increase the process precision and minimize thermal damage. The pulsed light sheets generated by the pulsed laser in combination with the photomask enables the parallel laser processing in contrast to the conventional serial processes.

In an embodiment, the pulsed laser may be a ultrafast laser. In another embodiment, the pulsed laser may comprise, but not limited to a picosecond laser, a femtosecond laser or a nanosecond laser.

In an embodiment of the present application, one of the sacrificial material and the structural material may be deposited on the substrate to form a first layer of the layers and the other one of the sacrificial material and the structural material may to form a further layer of the layers. In one embodiment of the present application, the additive process may be realized by electrodeposition, in which various metals can be deposited at controlled rates, achieving submicron resolution. The custom-developed electrolyte solutions can be used to optimize the electrodeposition outcome. i.e., density and uniformity. In one embodiment, the deposited layers may be planarized by the pulsed laser based on the sub-photomask defined for planarization. That is, the planarization of each of the deposited layers may be implemented by patterning.

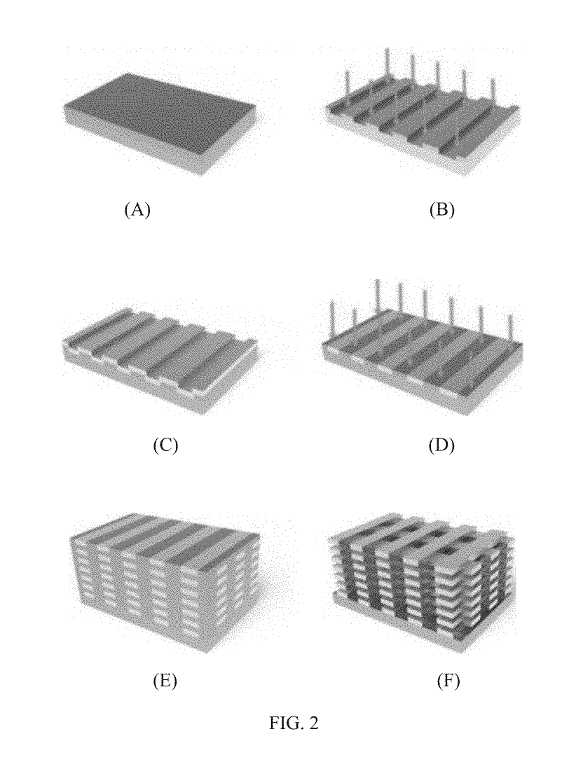

In an embodiment, the photomask may be a pattern defined by a spatial light modulator (SLM) required to build the 3D structure. The spatial light modulator may comprise, but not limited to, at least one of a digital micromirror device (DMD), a liquid-crystal-based SLM, a micro-electromechanical system (MEMS) mirror and acousto opto deflector (AOD). For example, the photomasks required for building the structures in FIG. 2 are just horizontal and vertical stripes. In another embodiment, the photomask comprises one or more sub-photomasks for each layer and each of the formed layers may be patterned based on a sub-photomask which is defined from the material of each layer. That is, different sub-photomasks may be used for patterning different layers, and the sub-photomask may be selected based on the materials of each layer.

In one embodiment, the deposited sacrificial materials may be etched to remove the redundant materials by using an etchant. Chemicals can be used to selectively remove supporting metals to form the desired 3D metal structures. To release the printed nickel structures, an etchant of high copper selectivity (Copper Etch BTP, Transene) is used with an etch rate of 150 A/sec. Typical etching processes are performed at room temperature and completed in several minutes.

An embodiment in which the structural material and the sacrificial material may be deposited by electrodeposition is described in the present application. However, it is understood that the structural material and the sacrificial material may be deposited by any known methods including, but not limited to, laser sintering/melting, sputtering, e-beam evaporation or polymerization.

FIG. 2 illustrates exemplary flows of the method for fabricating a 3D metal structure according to the embodiment. As shown in FIGS. 2(A) and 2(B), the sacrificial material is deposited on the substrate to form a layer, and then the formed layer is patterned via the pulsed light sheets by a pulsed laser, such as the femtosecond (fs) light sheets from the femtosecond laser according to the photomask. Then, the structural material is deposited on the patterned layer as shown in FIG. 2(C) and the deposited layer is planarized by a laser machining process via the fs light sheets as shown in FIG. 2(D). The above steps are repeated layer by layer as shown in FIG. 2(E). Finally, the sacrificial materials/layers are removed to fabricate the 3D metal structure as shown in FIG. 2(F), such as by etching.

It is known that the steps shown in FIGS. 2(A) and 2(B) may be omitted and the structural materials may be deposited on the substrate to achieve the same results. In another embodiment of the present application, the structural material may be deposited directly on the substrate to form a layer without the need of any sacrificial material. In this embodiment, the metal structure may be directly fabricated in a custom-prepared media, e.g., polyvinylpyrrolidone.

In an embodiment of the present application, the sacrificial material may be copper and the structural material may be nickel. It is appreciated that the sacrificial and structural materials are not limited to copper and nickel as described above. The exemplary examples of the sacrificial and structural materials that can be electrodeposited may comprise: nickel, copper, gold, silver, chromium, lead and lead alloys, tin and tin alloys, tin-lead alloys, zinc and zinc alloys, iron and iron alloys, palladium, semiconductors (silicon, gallium arsenide, gallium phosphide, indium compounds, etc), organic films (electron-conductive polymers). For example, gold, silver, tin, zinc, copper and nickel etc. can be used as a structural material while any other materials from the list can be selected as the sacrificial material. In addition, the “structural materials” can be more than one material, e.g., nickel and tin, while the sacrificial material can be copper. Structures made of more structural materials are also possible, depending on the availability of metal etchants. That is, the materials mentioned above can serve as the structural material or the sacrificial material, if suitable etchants are available (only etch the sacrificial material and be compatible with the structural material). It is noted that one printed structure can contain several kinds of materials.

In an embodiment of the present application, the photomask may be a programmable photomask generated by a digital micromirror device (DMD). Selected patterns are programmed to the DMD and the number of pulses can be precisely controlled by the DMD. The flatness of each layer may be adjusted by controlling a pixel refreshing rate, i.e., gray scale control of the digital micromirror device. For example, during the planarization step in FIG. 2(D), the light sheet pattern uniformity may be optimized by controlling the individual pixel scanning (refreshing) rate; when the pixel remains at the “on” state, the intensity is maximal; and when the pixel scanning rate, i.e., on-off time ratio, is varied, the intensity can be adjusted continuously.

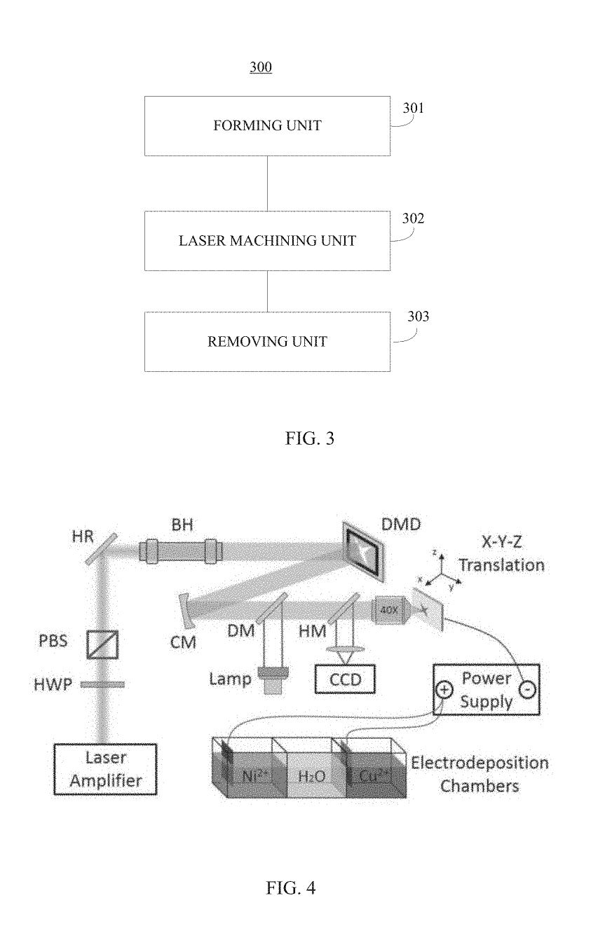

The method for fabricating the 3D metal structure has been described as above. Hereinafter, a system for fabricating a 3D metal structure will be described with reference to FIGS. 3 and 4. FIG. 3 illustrates a schematic block diagram of a system 300 for fabricating a 3D metal structure according to an embodiment of the present application and FIG. 4 illustrates an exemplary configuration of the system for fabricating a 3D metal structure according to an embodiment of the present application.

Referring to FIG. 3, the system 300 may include a forming unit 301 for forming at least one layer successively on a substrate, wherein each layer may comprise one of a sacrificial material and a structural material. The system 300 may further include a laser machining unit 302 for laser machining the formed layer by a pulsed laser, based on a photomask corresponding to the structure to be fabricated. The system 300 may further include a removing unit 303 for removing redundant materials from the formed layers to release the fabricated three-dimensional metal structure. With the system, a 3D metal structure at nanometer level resolution with high throughput can be fabricated.

FIG. 4 illustrates an exemplary configuration of the system according to an embodiment of the present application. It is appreciated that the system disclosed herein is not limited by the illustrated exemplary configuration.

The system may include a laser source (laser amplifier), a power control device, a high reflectance mirror (HR), a beam homogenizer, an image generation device, an optical device, a process observation device, and an electrodeposition device. In an embodiment, the laser source may be a regenerative femtosecond Ti: sapphire laser amplifier, for example, Spectra-Physics, Spitfire Pro 4.0 W; 800 nm, 100 fs. The diameter of the laser beam is approximately 10 mm with an M² value less than 1.3. The power control device may include a half wave plate (HWP) and a polarized beam splitter (PBS). The beam homogenizer (e.g., AdlOptica GmbH, piShaper_TisHP) may be used to convert the laser beam from a Gaussian profile to a flattop profile.

The image generation device may be a 2-D programmable digital device, e.g., a digital micromirror device (DMD). The DMD (e.g., DLP4500, Texas Instruments) contains millions of fast-switching micromirrors that has a bandwidth of 4.2-32.5 kHz. The optical device for guiding the laser beam from the laser source may include a concave mirror (CM), a half mirror (HM), and an objective lens (e.g., Nikon S Plan Fluor ELWD 40×). It is appreciated that the components of the optical device are not limited this, and other components for relaying laser beams may also be used. The concave mirror (CM) and the objective lens together form a 4-f system, enabling the pattern projection from the DMD to the focal plane of the objective lens. The process observation device may include a dichroic mirror (DM), a light source (a lamp), and a charge coupled device (CCD). The light source (an epi-illumination light source) and the CCD with a standard zoom lens (Canon EF 70-200 mm, f/4L IS) may be used for in situ process monitoring by reflectance through the long-pass dichroic mirror and the half mirror.

A sample to be fabricated may be mounted on a precision XYZ stage and connected to the negative side of a DC power supply which provides a stable current. The electrodeposition device may include three chambers which are filled with custom-developed solutions, e.g., the nickel electrolyte solutions, water, and custom-developed copper electrolyte solutions, respectively. In an embodiment, water cleaning is needed between alternate electrodeposition steps because electrolyte solutions may be polluted by other metal ions. By properly controlling the XYZ stage, the processes of electrodeposition can be fully automated.

As shown in FIG. 4, a top-flat fs laser beam is first guided to the DMD, which functions both as a diffractive optical element and a programmable photomask. This is true because the pixel size of the DMD is 10.8 micron that disperses the different spectrum of the fs laser into different directions. The objective lens then recombines the dispersed spectrum spatially and temporally at its focal region. Since the DMD surface and the focal plane are conjugated, the pattern on the DMD will be directly imaged to the focal plane, where the laser pulses are compressed, achieving high energy density and some level of depth discrimination. The 4-f system, i.e., the CM and the objective lens, controls the size of the projected image.

Further referring to FIG. 4, the quality of the copper and nickel electrolyte solutions of the electrodeposition device can be analyzed by a hull cell test which provides rapid information about brightness level, uniformity and impurities, guiding the optimization of dosage proportion in the solutions.

The thickness of the deposited metal layer is related to the current density and deposition time. The deposition rate can be estimated by an equation as below, derided from Faraday's Law:

$$t = \frac{n F ρ}{{A}_{ϖ t} \cdot \frac{I}{S}} h$$

where t represents deposition time; n represents the electron number; ρ represents the metal density; F represents the Faraday's contract; A_{ωt} represents the relative atomic mass; I represents the current; S represents the deposition area; and h represents the deposition thickness.

For the micro metal printing, 4 A/dm² is a proper current density for both the copper and nickel depositions.

Then, the relationship between the deposition thickness and deposition time for the copper and nickel is established as below:

$$\{ \begin{matrix}{t}_{Cu} = 68 s / µm \cdot {h}_{Cu} \\ {t}_{Nl} = 73 s / µm \cdot {h}_{Nl}\end{matrix}$$

The power supply may be used to provide steady currents so that the deposition layers can be precisely controlled via deposition time with high axial resolution, e.g., 10s nanometers. During the electrodeposition process, agitation is needed to provide sufficient metal ions near the cathode. Proper temperatures for copper and nickel deposition are 25° C. and 55° C. respectively.

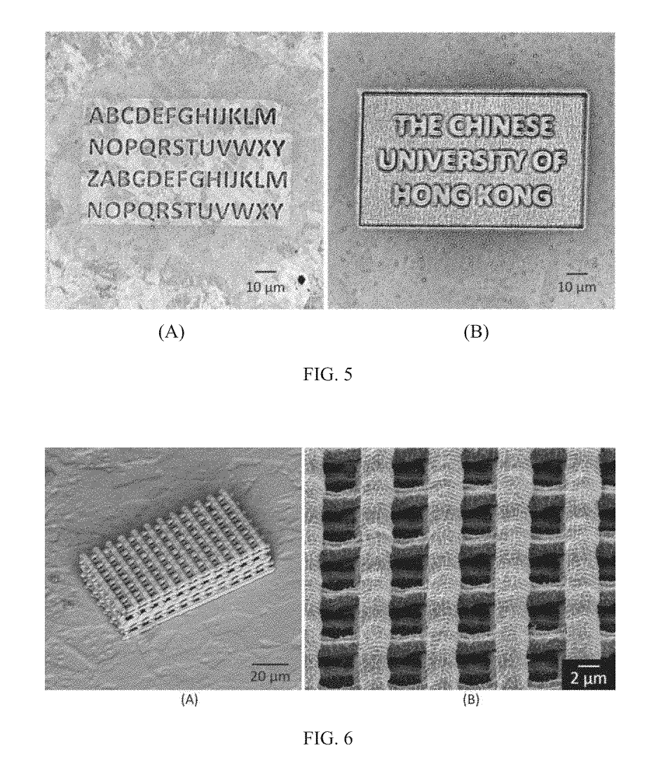

Next, some exemplary examples according to embodiments of the present application will be illustrated and described with reference to FIGS. 5-8. It is appreciated that the present application is not limited to the examples described hereinafter.

### Example 1

In an embodiment, the structural material may be deposited on the substrate and the structures can be fabricated without the need of sacrificial material by parallel femtosecond laser machining. Example 1 is illustrated to demonstrate the arbitrary patterning ability of the system of the embodiment according to the present application. In this example, a processing area is set to be 100×60 μm² so that each DMD pixel corresponds to an area of 76×76 nm². That is, the patterning resolution is only limited by the optical system instead of DMD pixels. The laser power used in the example 1 is 48 mW, i.e. 48 μJ/pulse, which is measured by a power meter (Coherent LabMax-TOP), several millimeters away from the focal plane of the objective lens. Selected patterns are programmed to the DMD and number of pulses is precisely controlled by the DMD. Two results fabricated in the Example 1 are shown in FIGS. 5(A) and 5(B), wherein negative English alphabets are illustrated in FIG. 5(A) and a positive CUHK logo is illustrated in FIG. 5(B).

Specifically, 30 pulses are fired to the nickel substrate/layer, i.e., the entire laser machining process is completed within 30 milliseconds (i.e., 30 pulses). In this example, a dry objective lens is used, so that some small particles are scattered on the substrate surface during the machining process. These particles may be removed and cleared up by firing a single laser pulse. Alternately, these particles may be removed by using water/oil immersion objective lenses and the system resolution may also be improved due to the higher numerical aperture (NA) of the water/oil lenses. With the dry objective lens, the system of the present application can achieve ˜800 nm resolution, which is close to the diffraction limited resolution. Higher resolution can be achieved by using the femtosecond laser with shorter wavelengths, e.g. 400 nm and 266 nm. Large processing areas can be achieved by (1) increasing the laser power or (2) stitching the patterns sequentially. Analyzed by a white light interferometer, the ablation depth increases quasi-linearly with increasing laser power and increasing pulse numbers. In this example, small particles scattered on the substrate surface during the machining process may be removed by using a single laser pulse from the pulsed laser or by using a water/oil-immersion objective lens.

From the images shown in FIGS. 5(A) and 5(B), it is noted the positive characters remain intact while the bottom of the processed area remains flat. Some ripples structures are also found in the processed area due to the interaction between femtosecond laser and metal substrates. According to the example, structures can be printed without the need of sacrificial material for photo-reduction-based or two-photon polymerization-based processes.

### Example 2

The Example 2 is illustrated to demonstrate multi-layer 3D microstructures and will be described with reference to FIGS. 6-8. In the example 2, the copper and nickel are deposited alternately and each layer has a thickness of 2 μm.

FIG. 6 illustrates an exemplary 10-layer log-pile structure fabricated by the method of the present application, wherein 6(A) is an isometric view and 6(B) is a zoom-in view. In the structure shown in FIG. 6, each layer contains nickel bars with a width and pitch of 3 μm and 7 μm respectively. After the deposition of each metal layer, 50 pulses, i.e., 50 milliseconds, are used to ablate and flatten the target. Note that most of the processing time is consumed by electrodeposition, etching and cleaning, while the time for parallel laser machining is on the scale of 10s milliseconds and is thus negligible. The total processing time for the log pile structure is ˜50 minutes. Contrarily, the conventional metal printing process is roughly 100-1000 times slower with a much lower resolution, i.e., 10 μm.

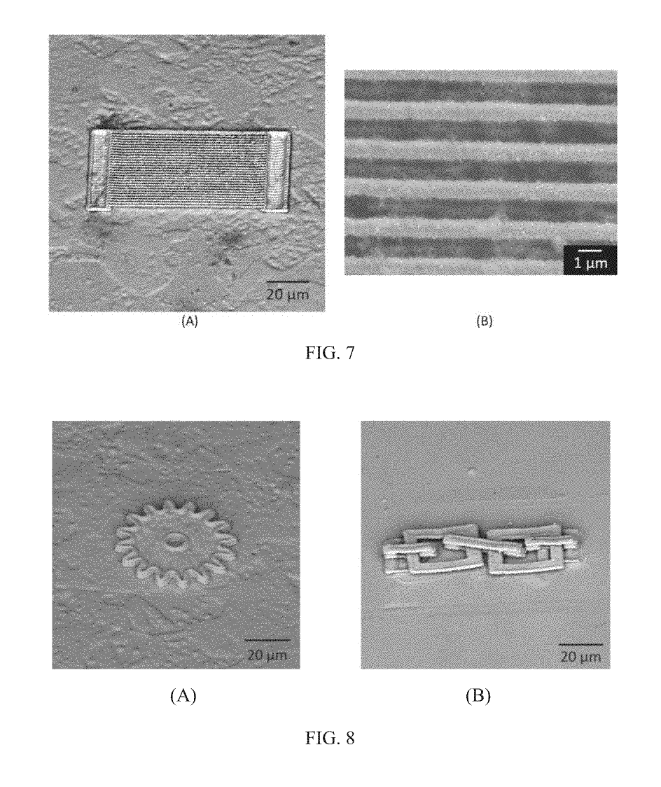

FIG. 7 illustrates an exemplary 2-layer suspended nanowire array structure fabricated by the method of the present application, wherein 7(A) is a top view and 7(B) is a zoom-in view. The nanowire array is attached to two bases. As shown in FIG. 7(B), the linewidth and pitch are 800 nm and 1.6 μm respectively. This lateral resolution is close to the diffraction limited resolution and the submicron level axial resolution can be achieved by controlling the electrodeposition time. To total fabrication time for the nanowire array structure is approximately 10 minutes. The array has an area of 90×50 μm².

FIG. 8 illustrates exemplary mechanical microstructures fabricated by the method of the present application to demonstrate the arbitrary 3D metal structure fabrication capability. Two selected mechanical microstructures, i.e., a 2-layer spur gear and a 6-layer chain structure are illustrated in FIGS. 8(A) and 8(B), respectively. In FIG. 8(A), one may observe the edges of the gear are slightly thicker; this is due to the higher current density at the edges during the electroplating processes. This negative effect can be reduced by (1) plating thinner metal layers each time or (2) adjusting/optimizing the exposure time of corresponding pixels on the DMD via gray scale control. In FIG. 8(B), the chain structure consists of multiple interlocked loops and allows relative motions after releasing. These micro-scale metal structures demonstrate the feasibility and effectiveness of the method and system provided in the present application.

The method and system of the present application can fabricate 3D metal structures having arbitrary geometries and nanometer level resolution, with high throughput. Comparing with the existing additive manufacturing systems, the system of the present application can fabricate pure and dense metal microstructures with high resolution (˜800 nm) and high throughput. The following Table 1 lists selected commercially available metal additive manufacturing systems with technical specifications. Note the feature resolution is larger than focus diameter due to heat diffusion. From table 1, it can be seen that the systems only achieve tens (>50 μm) to hundreds of micron resolution under different processing parameters.

TABLE 1
Commercial metal additive manufacturing systems

| | | Work | | Focus | Scan | | Layer | | |
|---|---|---|---|---|---|---|---|---|---|
| Brand&model | Laser type | volume | | diameter | speed | | thickness | | Cost |
| EOS PRECIOUS | 100 W/Yb-Fiber | 80 × 80 × 90 | mm³ | 30 μm | <7.0 | m/s | >30 | μm | €219,850 |
| M80 | laser | | | | | | | | |
| 3D SYSTEMS | 50 W/Fiber | 100 × 100 × 80 | mm³ | 50 μm | <10.0 | m/s | 10-15 | μm | US$309,181 |
| ProXTM 100 | Laser | | | | | | | | |
| Sinterstation ® | 200 W/Fiber | 250 × 250 × 320 | mm³ | 70 μm | <1.0 | m/s | 20-100 | μm | US$750,000 |
| Pro DM250 | Laser | | | | | | | | |

| | | | | | | | | |
|---|---|---|---|---|---|---|---|---|
| 3D MicroPrint | 30 W/Fiber | 27 × 27 × 20 | mm³ | 30 μm | NA | 1-5 | μm | >€1,000,000 |
| DMP60GP | Laser | | | | | | | |

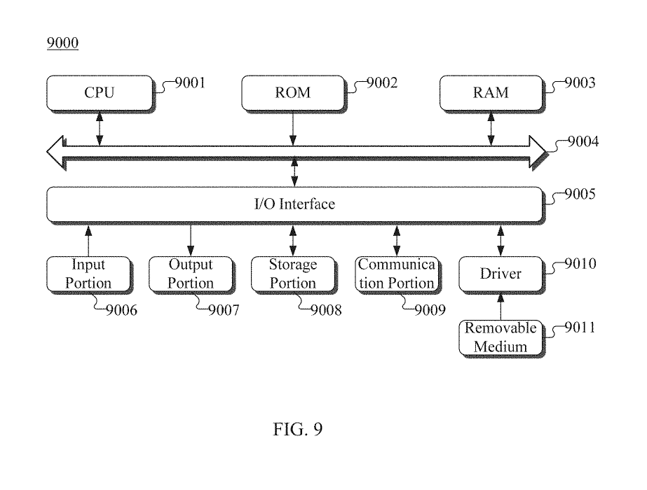

Referring now to FIG. 9, a schematic structural diagram of a computer system 9000 that is adapted for implementing the method and the apparatus according to an embodiment of the present application is shown.

As shown in FIG. 9, the computer system 9000 comprises a central processing unit (CPU) 9001, which may perform a variety of appropriate actions and processes according to a program stored in a read only memory (ROM) 9002 or a program loaded to a random access memory (RAM) 9003 from a storage portion 9008. RAM 9003 also stores various programs and data required by operations of the system 9000. CPU 9001, ROM 9002 and RAM 9003 are connected to each other via a bus 9004. An input/output (I/O) interface 9005 is also connected to the bus 9004.

The following components are connected to the I/O interface 9005: an input portion 9006 comprising a keyboard, a mouse and the like, an output portion 9007 comprising a cathode ray tube (CRT), a liquid crystal display (LCD), a speaker and the like; the storage portion 9008 comprising a hard disk and the like; and a communication portion 9009 comprising a network interface card, such as a LAN card, a modem and the like. The communication portion 9009 performs communication process via a network, such as the Internet. A driver 9010 is also connected to the I/O interface 9005 as required. A removable medium 9011, such as a magnetic disk, an optical disk, a magneto-optical disk and a semiconductor memory, may be installed onto the driver 3010 as required, so as to install a computer program read therefrom to the storage portion 9008 as needed.

In particular, according to the embodiment of the present disclosure, the method described above with reference to FIGS. 1 and 2 may be implemented as a computer software program. For example, the embodiment of the present disclosure comprises a computer program product, which comprises a computer program that tangibly included in a machine-readable medium. The computer program comprises program codes for executing the method in FIGS. 1 and 2. In such embodiments, the computer program may be downloaded from the network via the communication portion 9009 and installed, and/or be installed from the removable medium 9011.

The flow charts and the block diagrams in the figures illustrate the system architectures, functions, and operations which may be achieved by the systems, devices, methods, and computer program products according to various embodiments of the present application. For this, each block of the flow charts or the block diagrams may represent a module, a program segment, or a portion of the codes which comprise one or more executable instructions for implementing the specified logical functions. It should also be noted that, in some alternative implementations, the functions denoted in the blocks may occur in a different sequence from that marked in the figures. For example, two blocks denoted in succession may be performed substantially in parallel, or in an opposite sequence, which depends on the related functions. It should also be noted that each block of the block diagrams and/or the flow charts and the combination thereof may be achieved by a specific system which is based on the hardware and performs the specified functions or operations, or by the combination of the specific hardware and the computer instructions.

The units or modules involved in the embodiments of the present application may be implemented in hardware or software. The described units or modules may also be provided in a processor. The names of these units or modules do not limit the units or modules themselves.

As another aspect, the present application further provides a computer readable storage medium, which may be a computer readable storage medium contained in the device described in the above embodiments; or a computer readable storage medium separately exists rather than being fitted into any terminal apparatus. One or more computer programs may be stored on the computer readable storage medium, and the programs are executed by one or more processors to perform the formula input method described in the present application.

The above description is only the preferred embodiments of the present application and the description of the principles of applied techniques. It will be appreciated by those skilled in the art that, the scope of the claimed solutions as disclosed in the present application are not limited to those consisted of particular combinations of features described above, but should cover other solutions formed by any combination of features from the foregoing or an equivalent thereof without departing from the inventive concepts, for example, a solution formed by replacing one or more features as discussed in the above with one or more features with similar functions disclosed (but not limited to) in the present application.

What is claimed is:

1. A method for fabricating a three-dimensional metal structure, comprising:
forming one or more layers successively on a substrate, each of the layers comprising a structural material or a sacrificial material;
laser machining, by a pulsed laser, each of the formed layers based on a photomask corresponding to the structure to be fabricated; and
removing redundant materials from the formed layers to release the fabricated three-dimensional metal structure.

2. The method of claim 1, wherein the forming comprising:
depositing one of the sacrificial material and the structural material on the substrate to form a first layer of the layers; and
depositing the other one of the sacrificial material and the structural material to form a further layer of the layers.

3. The method of claim 1, wherein the photomask comprises one or more sub-photomasks for each layer, and the laser machining comprises:
patterning each of the formed layers, based on the sub-photomask which is defined from the material of each layer.

4. The method of claim 3, wherein the laser machining further comprises:
planarizing each of the formed layers by the pulsed laser based on the sub-photomask which is defined for planarization.

5. The method of claim 2, wherein the removing comprising:
etching, by an etchant, the deposited sacrificial materials to remove the redundant materials.

6. The method of claim 1, wherein each of the sacrificial material and the structural material is at least one selected from gold, silver, tin, zinc, copper, nickel, chromium lead and lead alloys, tin and tin alloys, tin-lead alloys, zinc and zinc alloys, iron and iron alloys, palladium, silicon, gallium arsenide, gallium phosphide, indium compounds, and electron-conductive polymers.

7. The method of claim 2, wherein the structural material and the sacrificial material are deposited by any one of electrodeposition, laser sintering/melting, sputtering, e-beam evaporation or polymerization.

8. The method of claim 1, wherein the photomask is a programmable photomask generated by a spatial light modulator (SLM).

9. The method of claim 8, wherein the flatness of each layer is adjustable by controlling a pixel refreshing rate of the spatial light modulator.

10. The method of claim 9, wherein the spatial light modulator comprises at least one of a digital micromirror device, a liquid-crystal-based SLM, a micro-electromechanical system (MEMS) mirror and acousto opto deflector (AOD).

11. A system for fabricating a three-dimensional metal structure, comprising:
at least one processor; and
a memory storing instructions, which when executed by the at least one processor, cause the at least one processor to perform operations comprising:
forming one or more layers successively on a substrate, each of the layers comprising a sacrificial material or a structural material;
laser machining, by a pulsed laser, each of the formed layers based on a photomask corresponding to the structure to be fabricated; and
removing redundant materials from the formed layers to release the fabricated three-dimensional metal structure.

12. The system of claim 11, wherein the forming comprising:
depositing one of the sacrificial material and the structural material on the substrate to form a first layer of the layers; and
depositing the other one of the sacrificial material and the structural material to form a further layer of the layers.

13. The system of claim 11, wherein the photomask comprises one or more sub-photomasks for each layer, and the laser machining comprises:
patterning each of the formed layers, based on the sub-photomask which is defined from the material of each layer

14. The system of claim 13, wherein each of the formed layers is planarized by the pulsed laser based on the sub-photomask which is defined for planarization.

15. The system of claim 12, wherein the removing comprising:
etching, by an etchant, the deposited sacrificial materials to remove the redundant materials.

16. The system of claim 11, wherein each of the sacrificial material and the structural material is at least one selected from gold, silver, tin, zinc, copper, nickel, chromium, lead and lead alloys, tin and tin alloys, tin-lead alloys, zinc and zinc alloys, iron and iron alloys, palladium, silicon, gallium arsenide, gallium phosphide, indium compounds, and electron-conductive polymers.

17. The system of claim 12, wherein the structural material and the sacrificial material are deposited by any one of electrodeposition, laser sintering/melting, sputtering, e-beam evaporation or polymerization.

18. The system of claim 11, wherein the photomask is a programmable photomask generated by a spatial light modulator, and the flatness of each layer is adjustable by controlling a pixel refreshing rate of the spatial light modulator.

19. The system of claim 18, wherein the spatial light modulator comprises one of a digital micromirror device, a liquid-crystal-based SLM, a micro-electromechanical system (MEMS) mirror and AOD.

20. The system of claim 11, wherein the pulsed laser comprises one of a picosecond laser, a femtosecond laser and a nanosecond laser.

21. A system for fabricating a three-dimensional metal structure, comprising:
a pulsed laser source for providing pulsed light sheets;
a digital micromirror device for generating a programmable photomask;
a deposition device for depositing a sacrificial material or a structural material;
at least one processor; and
a memory storing instructions, which when executed by the at least one processor, cause the at least one processor to perform operations, the operations comprising:
depositing one of the sacrificial material and the structural material on a substrate to form a first layer;
patterning the formed layer by the pulsed light sheets in a parallel approach, based on the photomask corresponding to the structure to be fabricated;
depositing the other one of the sacrificial material and the structural material on the patterned layer to form a further layer;
planarizing the deposited layer by the pulsed light sheets;
repeating the above steps until a final layer is formed; and
removing redundant materials by an etchant from the formed layers to release the fabricated three-dimensional metal structure.

22. The system of claim 21, wherein the photomask comprises one or more sub-photomasks for each layer, and each of the formed layers is patterned, based on the sub-photomask which is defined from the material of each layer.
